(19) United States
(12) Patent Application Publication
(10) Pub. No.: US 2005/0138619 A1
(43) Pub. Date: Jun. 23, 2005

(54) Method for remotely acquiring customized embedded operating system through computer network

(76) Inventor: Jen-Fu Tsai, Sindian City (TW)

Correspondence Address: Yi-Wen Tseng, 4331 Stevens Battle Ln., Fairfax, VA, 22033, US

(21) Appl. No.: 10/742,850

(22) Filed: Dec. 23, 2003

(51) Int. Cl. G06F 9/445

(52) U.S. Cl. 717/177

(57) ABSTRACT

A method of acquiring a customized embedded operating system through a computer network, particularly for the embedded operating system in componentized form such as Windows CE used in the computer. A specific working website is provided through the network structure. The website displays a list of components selectable through a user-friendly interface. The user can click and select the required component at the website. The server performs composition and edition automatically upon reception of the selection. After the edition, the required component is transmitted from the website to the user, or stored in the network allowing the user to download.

### BACKGROUND OF THE INVENTION

The present invention relates in general to a method of acquiring a customized embedded operating system through a network interface, and more particular, to a method using a user-friendly interface to acquire a customized embedded operating system provided by a website.

The embedded operating system provides the operating system for to embedded device such as ATM machine, electronic piano, electronic cashier, and personal data assistant. Examples of the operating system include Windows CE, NET, and Window XP Embedded developed by Microsoft Inc. The difference between such embedded operating system and those used in the desktop and laptop computer includes the componentized form used in the former. The componentized form partitions the operating system into multiple functional components allowing the user to select the require component according to specific requirement. The selected component is then composed and edited into a complete operating system. Thereby, the versatile application and hardware characteristic such as small volume, less storage space and slower speed can be implemented. There is no redundant space in the operating system, and the required storage space for such operating system is reduced. However, this embedded operating system normally relies on platform development tool such as Platform builder (PB) developed by Microsoft to complete the composition of the embedded operating system. The cost of the platform builder is high (about US$1,000). In addition, as the platform builder is designed particularly for the embedded developer, the interface is very professional. Therefore, the threshold for operating such software is very high. Only those with whole has taken the professional trainings are able to operate such software. For each embedded developer, the average yearly wage is about US$40,000, or the four-day training cost is about US$2,000 each person. Even through the professional training course, the operator still needs some time to become familiar with such software. Therefore, the existing embedded operating system developed by the platform builder is very costly currently.

### BRIEF SUMMARY OF THE INVENTION

The present invention provides a method of acquiring customized embedded operating system through a network. A specific website is provided from a remote server to a user (an embedded developer). The website is designed by a humanized, instinctive and user-friendly interface. Each functional component of the embedded operating system is converted into a pattern or a text on a selection list. Even a non-professional user can do the selection straightforwardly. After the required component is selected, the selection result is fed back to the server. The server then automatically composes and edits the components into a complete operating system. The server can either transmit the operating system to the user through the network, or stores it in the website allowing the user to download therefrom. In this manner, the expensive professional platform builder is not required, and the user does not need special training to operate the system.

To achieve the above objective, a platform building tool similar to the platform builder is installed in the server. The user can browse an operating website, which is a human-machine interface of the platform developing tool, via the network. After selecting the required operating system component, the selecting result is sent to the server, and the platform developing tool automatically performs composition and edition. The composed and edited operating system is then transmitted to the user via the network, or ready to be downloaded by the user.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These, as well as other features of the present invention, will become apparent upon reference to the drawings wherein:

FIG. 1 shows the system structure of the present invention;

FIG. 2 shows an operating website; and

FIG. 3 shows a flow chart of the method provided by the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

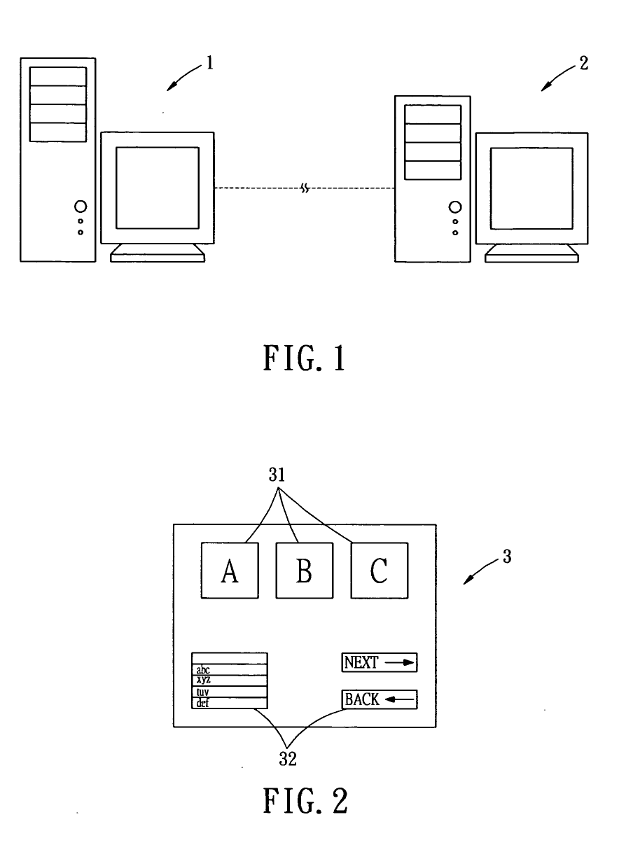

Referring to FIG. 1, the system structure comprises a server 1 and at least one network connecting and browsing apparatus 2. The network connecting and browsing apparatus 2 includes a desktop, laptop or palm computer, a personal data assistant and an internet cell phone that includes WAP and GPRS functions, for example. The network includes either an internet or an intranet. The server 1 includes an application software as a platform development tool allowing the user, that is, the embedded developer to log in. The user connects the server 1 via the network browser such as the Internet Explorer developed by Microsoft Inc. of the network connecting and browsing apparatus 2. Thereby, an operating web page 3 as shown in FIG. 2 can be obtained. As shown, the web page 3 provides a selection menu 32 of which various functional components of the embedded operating system are represented by patterns 31 or texts 32. Following the step-by-step selection, all the required components are then selected and transmitted to the server 1. Upon reception of the required components, the server 1 automatically composes and edits the selected components to generate a resultant file or directory of the operating system. The file or directory can then be sent to the user automatically by electronic mail or instant message such as ICQ. Alternatively, the file or directory can be stored in the server 1 allowing the user to download therefrom. The file or directory can be formatted as multiple files/directories or a single image file. The user can then save the resultant file or directory into a storage apparatus such as a memory card, hard drive or memory. The embedded device can thus perform operation by the operating system.

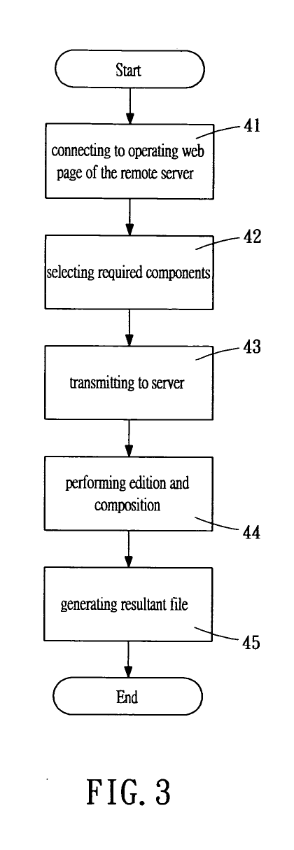

FIG. 3 shows the flow chart of the method provided by the present invention. In the first step (41), the user uses the network connecting and browsing apparatus 2 to open the operating web page 3 of the remote server 1 via the network. In the second step (42), the user selects the required components from the web page 3. In the third step (43), the required components as selected are transmitted to the server 1. In the fourth step (44), the server performs edition and composition after receiving the required components. In the fifth step (45), a resultant file or directory of an operating system is generated allowing the user to download or retrieve.

According to the above, the present invention provides a fast and convenient method for an embedded developer to obtain an operating system. This method allows the user to obtain the operating system without purchasing the expensive and complicated platform builder.

This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A method of acquiring a customized embedded operating system through a computer network, comprising:
using a network connecting and browsing apparatus to connect a server through a network, wherein the server includes an application software of a platform development tool allowing a user to log in;
open a web page of the server, the web page providing a selection menu of functional components;
selecting required functional components of the of the embedded operating system;
transmitting the selected required functional components to the server;
automatically generating a resultant file or directory of the embedded operating system by the server.

2. The method of claim 1, wherein the network includes an internet or an intranet.

3. The method of claim 1, wherein the functional components are represented by patterns or texts.

4. The method of claim 1, further comprising transmitting the resultant file or directory to the user through the network.

5. The method of claim 1, further comprising transmitting the resultant file or directory to the user through electronic mail or instant message.

6. The method of claim 1, further comprising:
storing the resultant file or directory in the server; and
downloading the resultant file or directory from the server.

7. The method of claim 1, wherein the network connecting and browsing apparatus includes a computer.

8. The method of claim 1, wherein the computer includes a desktop, laptop or palm computer.

9. The method of claim 1, wherein the network connecting and browsing apparatus includes a personal data assistant.

10. The method of claim 1, wherein network connecting and browsing apparatus includes an internet cell phone.

11. The method of claim 1, wherein the resultant file or directory includes multiple files or directories, or a single image file.
